(19) United States
(12) Patent Application Publication
(10) Pub. No.: US 2023/0365280 A1
(43) Pub. Date: Nov. 16, 2023

(54) Lightweight Foldable Robotic Arm For Drones

(71) Applicant: IDAHO STATE UNIVERSITY, Pocatello, ID (US)

(72) Inventors: Taher Deemyad, POCATELLO, ID (US); Parker Wegrowski, POCATELLO, ID (US); Jacob Lemrick, POCATELLO, ID (US); Wesley Thomas, POCATELLO, ID (US); Kyler Bingham, POCATELLO, ID (US); Anish Sebastian, Idaho Falls, ID (US)

(21) Appl. No.: 18/316,532

(22) Filed: May 12, 2023

Related U.S. Application Data
(60) Provisional application No. 63/341,759, filed on May 13, 2022.
(60) Provisional application No. 63/341,756, filed on May 13, 2022.
(60) Provisional application No. 63/341,744, filed on May 13, 2022.

(51) Int. Cl. B64U 20/70; B64U 10/14; B25J 18/02; B25J 9/12; B25J 9/10

(52) U.S. Cl. CPC B64U 20/70; B25J 9/107; B25J 9/123; B25J 9/126; B25J 18/025; B64U 10/14

(57) ABSTRACT

An unmanned aerial vehicle includes a body with an arm mounted to a side of the body. The unmanned aerial vehicle also includes an actuator coupled to the arm. The actuator is configured to move the arm between a retracted position and an extended position. The actuator moves within a single degree of freedom to move the arm between the retracted position and the extended position.

### CROSS-REFERENCE TO RELATED APPLICATIONS

This application claims benefit of the filing dates of U.S. Provisional Pat. Application Serial No. 63/341,744, having a filing date of May 13, 2022, U.S. Provisional Pat. Application Serial No. 63/341,759, having a filing date of May 13, 2022, and U.S. Provisional Pat. Application Serial No. 63/341,756, having a filing date of May 13, 2022, each of which is incorporated herein by reference for all purposes.

### FIELD

The present subject matter relates generally to unmanned aerial vehicles, and more particularly to unmanned aerial vehicles and robotic arms for unmanned aerial vehicles.

### BACKGROUND

Unmanned aerial vehicles (“UAV”), sometimes also referred to as drones, are used for a variety of tasks. A quadcopter is an example of a UAV. UAVs, such as quadcopters, may be used to perform tasks that are too difficult or too dangerous for humans or ground vehicles to accomplish, such as in harsh environments, locations where terrain is rough and speed is important, or locations high above the ground. For example, UAV’s may be used to collect samples, repair power lines, or harvest produce from tall trees.

Providing a UAV with a robotic arm and an end effector, such as a gripper, thereon may enhance the UAV’s capabilities for such tasks. A robotic arm may, however, undesirably increase the weight, drag, or power consumption of the UAV.

Accordingly, an improved UAV and robotic arm therefor with features such as light weight, improved aerodynamics, e.g., when the robotic arm is not deployed, and minimal power consumption, e.g., during actuation, would be useful.

### BRIEF DESCRIPTION

Aspects and advantages of the invention will be set forth in part in the following description, or may be apparent from the description, or may be learned through practice of the invention.

In a first exemplary embodiment, an unmanned aerial vehicle is provided. The unmanned aerial vehicle includes a body having an upper side and a lower side opposite the upper side. The unmanned aerial vehicle also includes at least one rotor coupled to the body. The rotor is configured to generate lift in an upward direction. The unmanned aerial vehicle further includes an arm mounted to the lower side of the body and an actuator coupled to the arm. The actuator is configured to move the arm between a retracted position and an extended position. The actuator moves within a single degree of freedom to move the arm between the retracted position and the extended position.

In a second exemplary embodiment, an unmanned aerial vehicle is provided. The unmanned aerial vehicle includes a body with an arm mounted to a side of the body. The unmanned aerial vehicle also includes an actuator coupled to the arm. The actuator is configured to move the arm between a retracted position and an extended position. The actuator moves within a single degree of freedom to move the arm between the retracted position and the extended position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an unmanned aerial vehicle according to one or more embodiments of the present subject matter.

FIG. 2 provides another perspective view of the unmanned aerial vehicle of FIG. 1.

FIG. 3 provides a side view of an arm for an unmanned aerial vehicle according to one or more embodiments of the present disclosure in a retracted position.

FIG. 4 provides a side view of the arm of FIG. 3 in a first intermediate position.

FIG. 5 provides a side view of the arm of FIG. 3 in a second intermediate position.

FIG. 6 provides a side view of the arm of FIG. 3 in an extended position.

FIG. 7 provides an exploded view of the arm of FIG. 3.

FIG. 8 provides a perspective view of the arm of FIG. 3 in the retracted position and an actuator.

FIG. 9 provides a perspective view of the arm of FIG. 3 in the extended position and the actuator of FIG. 8.

FIG. 10 provides a perspective view of a shell for a robotic arm according to one or more exemplary embodiments of the present disclosure.

FIG. 11 provides a side view of the exemplary shell of FIG. 10 and an exemplary robotic arm therein according to one or more additional exemplary embodiments of the present disclosure.

FIG. 12 provides a perspective view of the exemplary shell of FIG. 10 in an open position and the exemplary robotic arm of FIG. 11 in an intermediate position.

FIG. 13 provides a perspective view of the exemplary shell of FIG. 10 in an open position and the exemplary robotic arm of FIG. 11 in an extended position.

FIG. 14 provides a perspective view of the exemplary robotic arm of FIG. 11 in the retracted position.

FIG. 15 provides a perspective view of the exemplary robotic arm of FIG. 11 in the extended position.

FIG. 16 provides another perspective view of the exemplary robotic arm of FIG. 11 in the extended position.

FIG. 17 provides an exploded view of the exemplary shell of FIG. 10 and the exemplary robotic arm of FIG. 11.

FIG. 18 provides another exploded view of the exemplary shell of FIG. 10 and the exemplary robotic arm of FIG. 11.

FIG. 19 provides a perspective view of an arm for an unmanned aerial vehicle according to one or more additional exemplary embodiments of the present disclosure in an extended position.

FIG. 20 provides a side view of the exemplary arm of FIG. 19 in a retracted position, with an extended position and several intermediate positions of the exemplary arm shown in dashed lines.

FIG. 21 provides an exploded view of the exemplary arm of FIG. 19.

FIG. 22 provides a perspective view of an exemplary arm for an unmanned aerial vehicle according to one or more additional embodiments of the present disclosure.

FIG. 23 provides another perspective view of the exemplary arm of FIG. 22.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees either clockwise or counterclockwise with the vertical direction V.

The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components.

The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

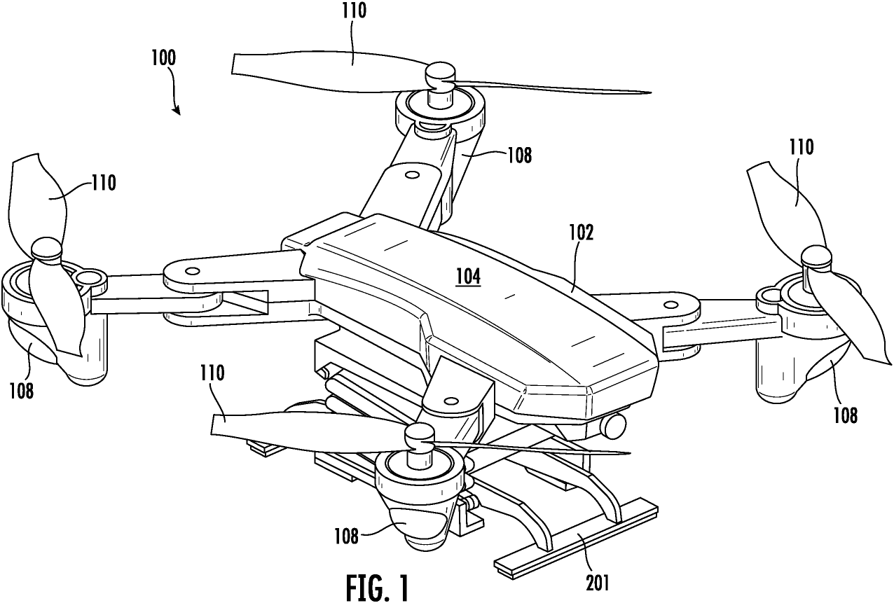

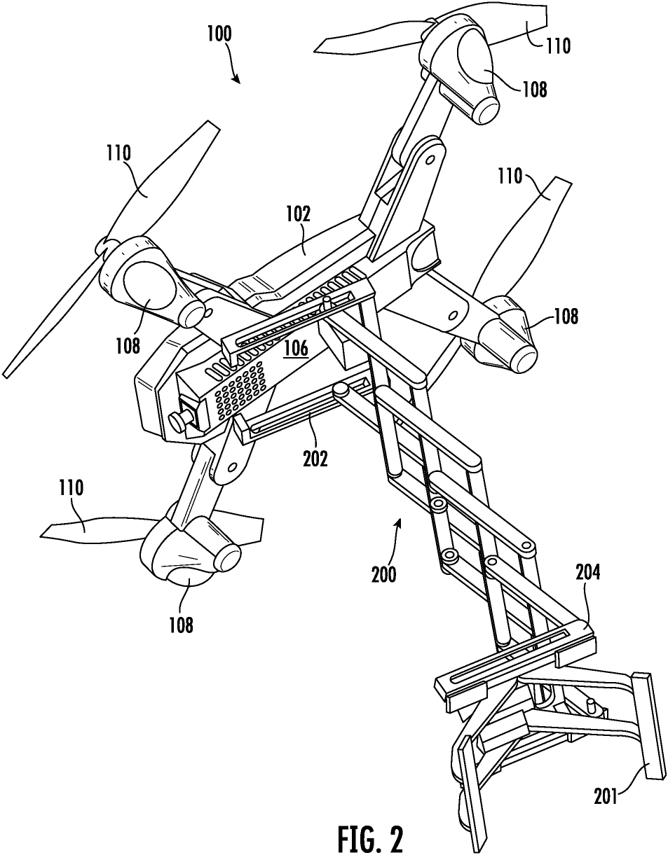

As illustrated for example in FIGS. 1 and 2, embodiments of the present disclosure include unmanned aerial vehicles, such as the exemplary unmanned aerial vehicle 100 illustrated in FIGS. 1 and 2. Unmanned aerial vehicles may also be referred to as “UAVs” or drones. In particular, the exemplary embodiment of the UAV 100 illustrated in FIGS. 1 and 2 is also known as a quadcopter. In additional embodiments, folding robotic arms as described hereinbelow may be used with any suitable UAV 100, such as a dual rotor UAV, other multirotor UAV (e.g., a tricopter or a multirotor UAV having more than four rotors), single rotor UAV, fixed-wing UAV, or other similar UAVs.

Unmanned aerial vehicles generally include a main body 102 or chassis and one or more lift-generating and/or propulsion (thrust-generating) mechanisms. A UAV further includes one or more controllers, e.g., integrated circuits, including a wireless communication module and antenna for sending and receiving remote commands, instructions, and other information. A UAV may also include a vision system, e.g., comprising a camera, global positioning system (GPS), gyroscopes, and other components or accessories, such as a manipulator, e.g., a robotic arm such as the exemplary robotic arms described hereinbelow, which are communicatively coupled with the controller and may be operated by the controller, e.g., in response to remote commands received wirelessly by the controller.

As may be seen in FIGS. 1 and 2, the UAV 100, e.g., quadcopter 100, may include an upper 104 side and a lower side 106 opposite the upper side 104, such as an upper side 104 of the main body 102 and a lower side 106 of the main body 102. The terms “upper” and “lower” may be defined with respect to each other, e.g., as facing in opposite directions, and with respect to a vertical direction or orientation, e.g., wherein the UAV 100 is operable and configured to move upward along the vertical direction when the lift-generating mechanism is activated. For example, the illustrated quadcopter 100 includes four rotors 108 which generate lift when rotated. As those of ordinary skill in the art will recognize and understand, each rotor 108 includes a propeller 110 coupled to a motor (not shown), and each motor may be controlled, e.g., selectively activated or deactivated and the speed or direction thereof adjusted, by the controller of the UAV 100. By varying the speed of rotation, direction of rotation, or angle of each rotor 108 or at least one rotor 108, the UAV 100 may move horizontally, e.g., in a horizontal direction generally parallel to the ground or generally perpendicular to the vertical direction, due to the varying amount or direction of lift generated by the rotors 108 which are operated at different speeds, rotated in different directions, or at various angles. Such variations across and among the rotors 108 also permit variations in and control of the pitch, yaw, and roll of the UAV 100.

The controller may be generally configured to facilitate UAV operation. In this regard, the lift and/or propulsion mechanism and other components, such as the vision system (if provided) or robotic arm (if provided) may be in communication with the controller such that controller may receive control inputs from user input devices, and may otherwise regulate operation of the UAV 100. For example, signals generated by the controller may activate or operate the UAV 100, including any or all system components, subsystems, or interconnected devices, in response to user inputs and other control commands wirelessly received by the controller. The various components of the UAV 100 may be in communication with the controller via, for example, one or more signal lines or shared communication busses. In this manner, Input/Output (“I/O”) signals may be routed between the controller and various operational components of the UAV 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate operation of the UAV, such as the vision system may include a dedicated and specialized controller separate from or onboard a main controller, similarly, the robotic arm may also or instead be operated by a dedicated controller. Alternatively, controller 166 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

The controller may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, the controller may be operable to execute programming instructions or micro-control code associated with an operation of the UAV 100. In this regard, the instructions may be software or any set of instructions that when executed by the processing device, cause the processing device to perform operations, such as running one or more software applications, receiving user input, processing user input, etc. Moreover, it should be noted that the controller as disclosed herein is capable of and may be operable to perform any methods, method steps, or portions of methods as disclosed herein. For example, in some embodiments, methods disclosed herein may be embodied in programming instructions stored in the memory and executed by the controller.

The memory devices may also store data that can be retrieved, manipulated, created, or stored by the one or more processors or portions of the controller. The data can include, for instance, data to facilitate performance of methods described herein. The data can be stored locally (e.g., on the controller) in one or more databases and/or may be split up so that the data is stored in multiple locations. In addition, or alternatively, the one or more database(s) can be connected to the controller through any suitable network(s), such as through a high bandwidth local area network (LAN) or wide area network (WAN). In this regard, for example, the controller may further include a communication module or interface that may be used to communicate with one or more other component(s) of the UAV 100, the controller, an external controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

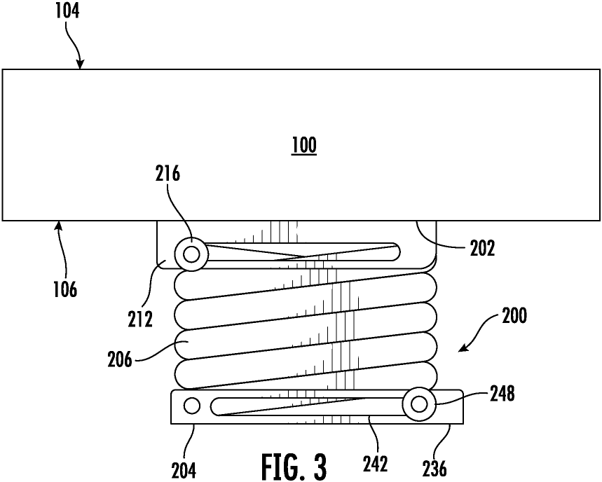

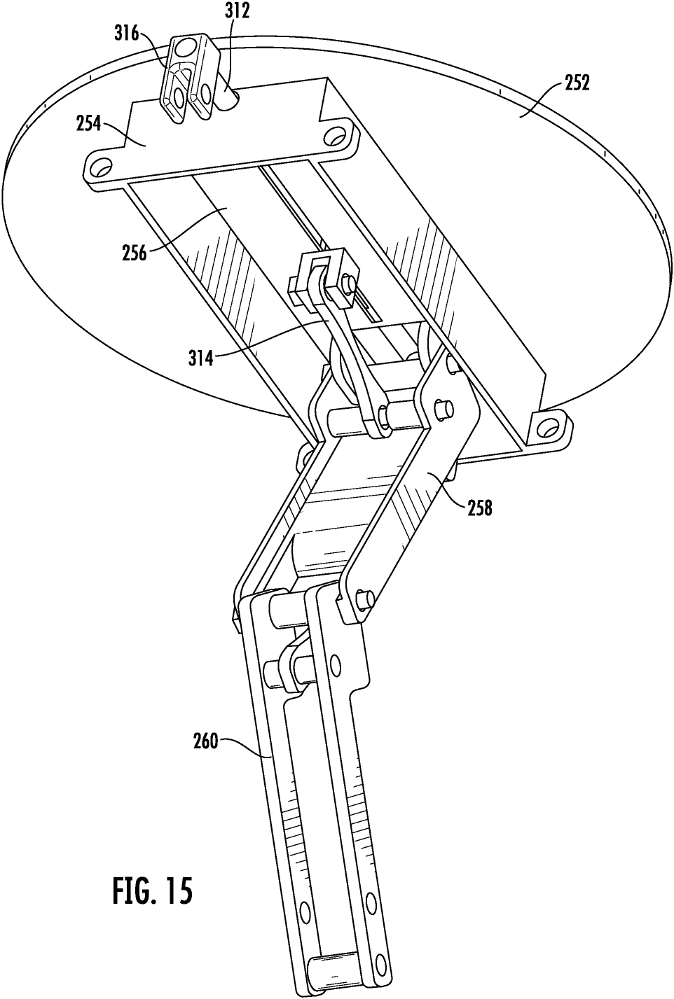

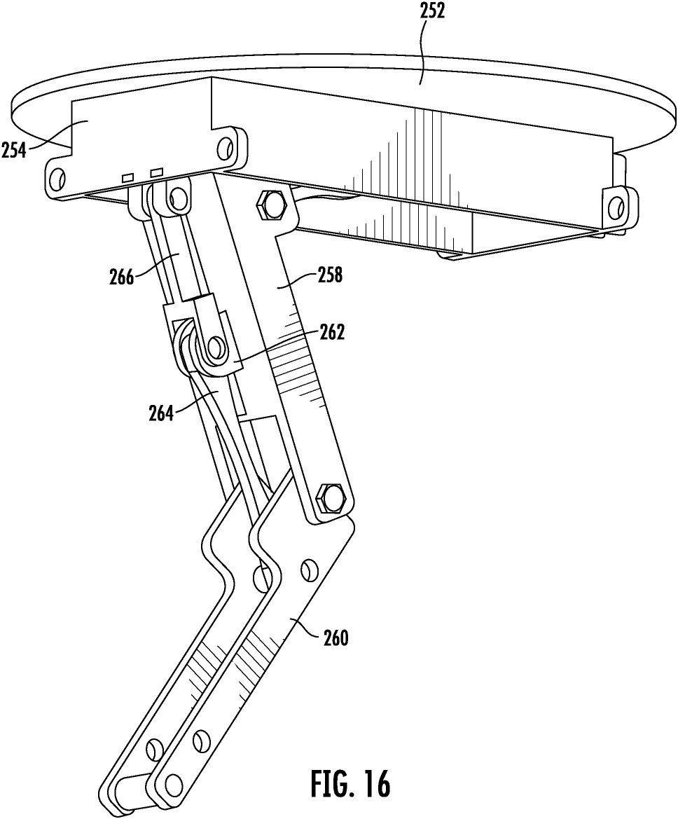

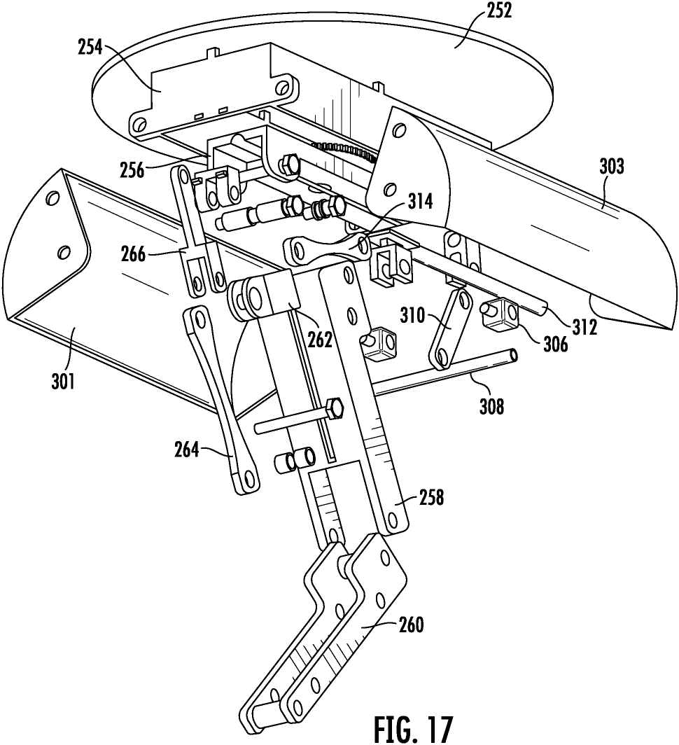

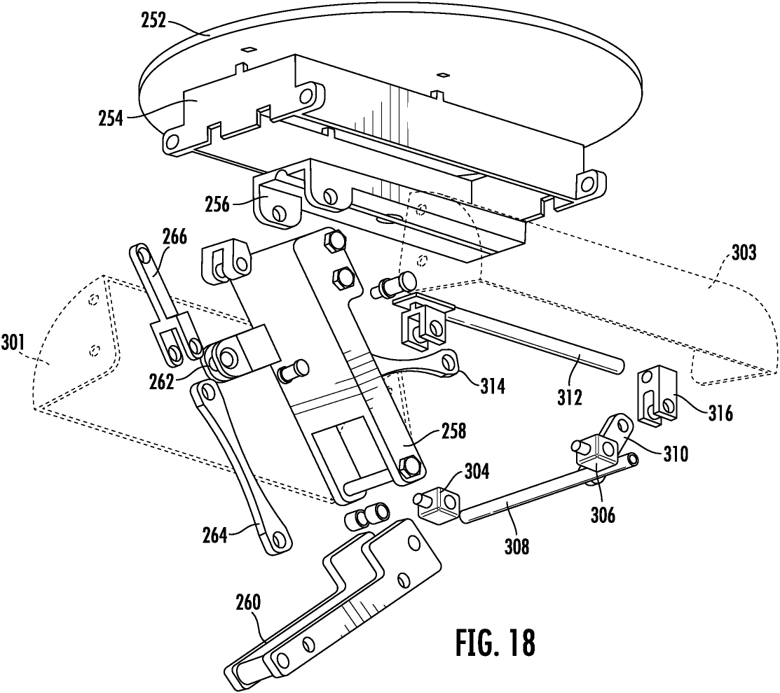

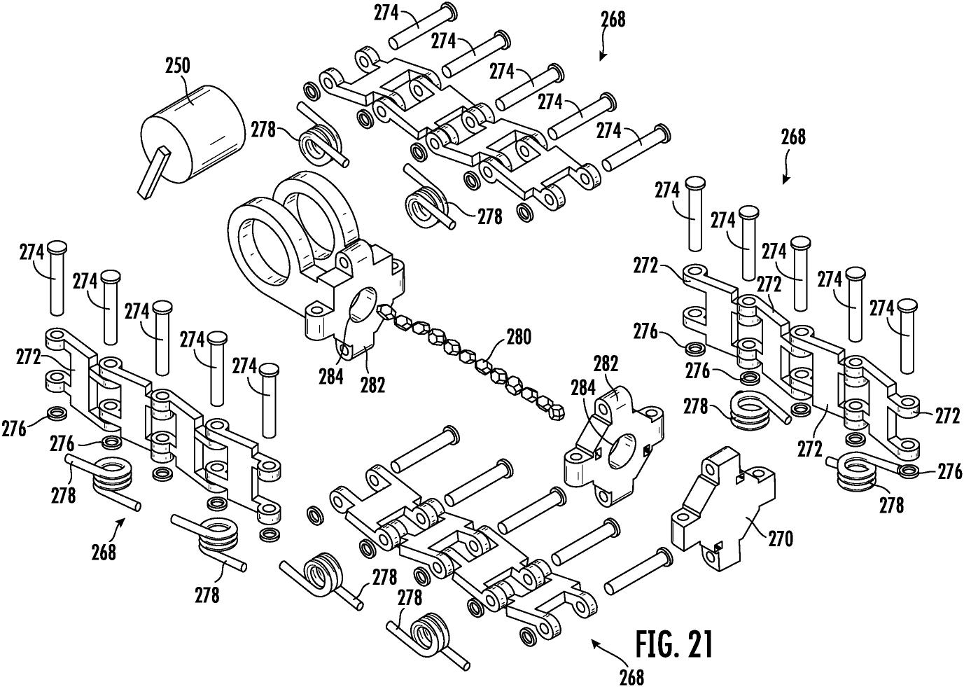

Returning to FIGS. 1 and 2, a folding robotic arm 200 may be mounted to the UAV 100, such as at a proximal end 202 of the arm 200. An end effector 201, e.g., gripper or any other suitable device which permits interaction with external objects, may be provided at a distal end 204 of the arm 200. Any of the exemplary folding robotic arms 200 according to the embodiments illustrated in FIGS. 3-23 may be mounted to any suitable UAV 100, such as but not limited to the exemplary quadcopter 100 shown in FIGS. 1 and 2.

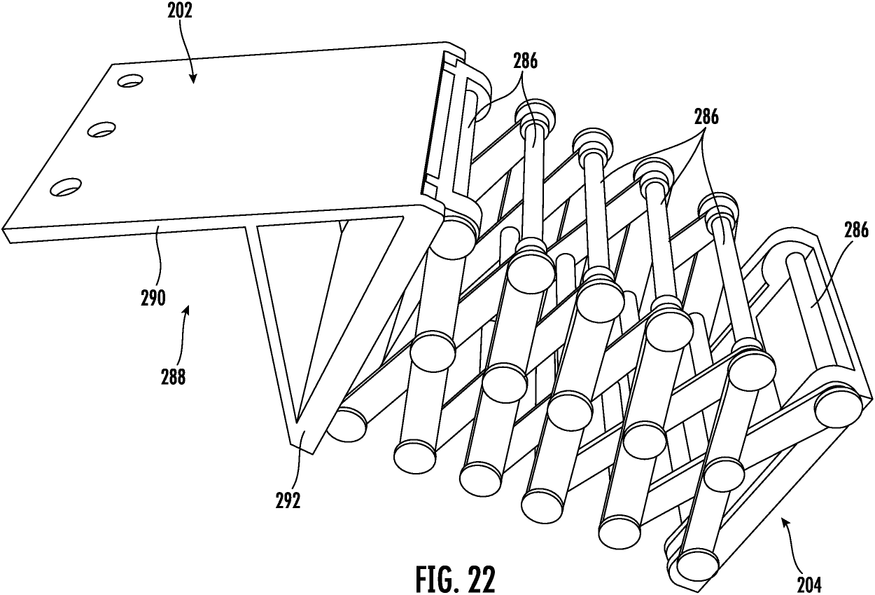

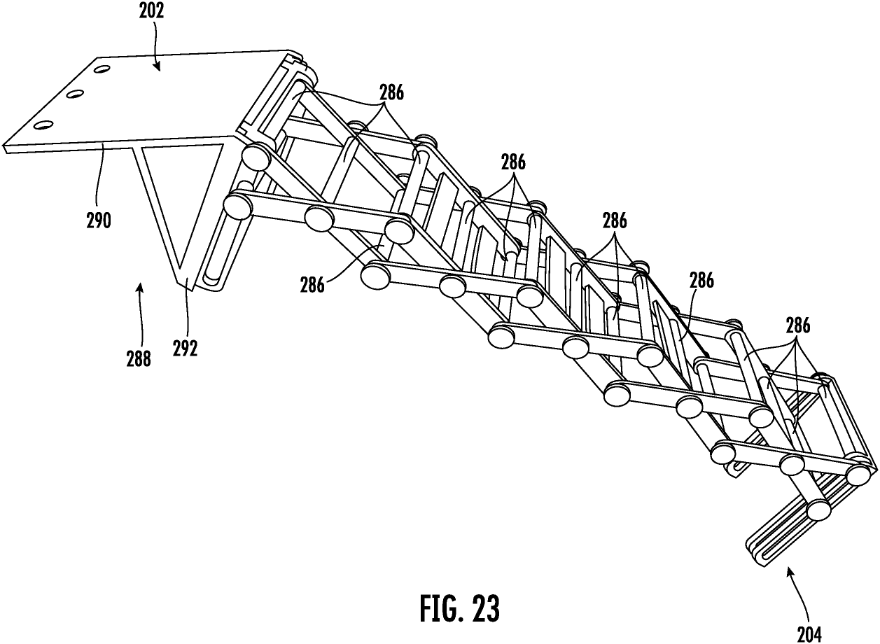

Referring now to FIGS. 3-9, in some embodiments, the folding robotic arm 200 may comprise one or more scissor arms 206. For example, the folding robotic arm 200 may include a first scissor arm 206 and a second scissor arm 206 as in the illustrated embodiment. The first and second scissor arms 206 may be mirrored and may be parallel to each other. In some embodiments, one or more cross links 286 (see, e.g., FIGS. 22 and 23) may be provided between the first and second scissor arms 206, such as extending from one scissor arm 206 to the other generally perpendicular to both scissor arms 206. Such cross links 286 may promote synchronous movement, e.g., extending and retracting, of the scissor arms 206 of the folding robotic arm 200.

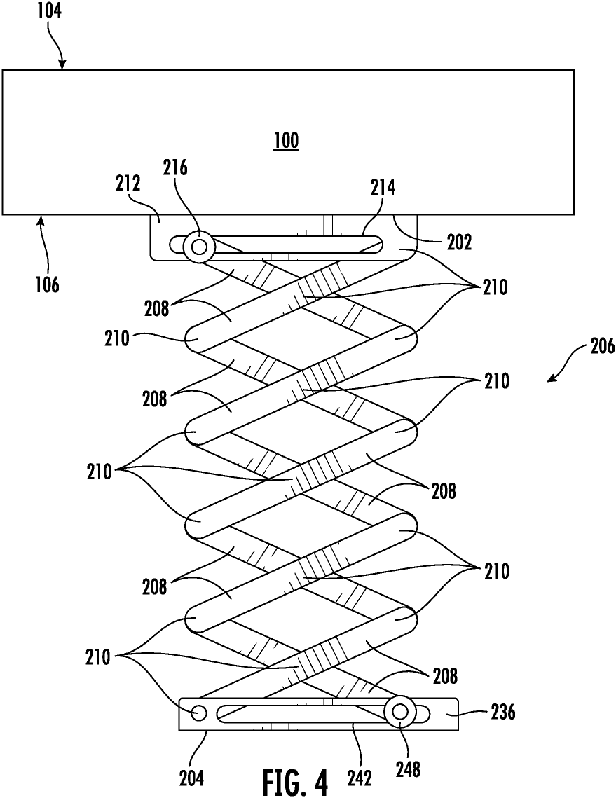

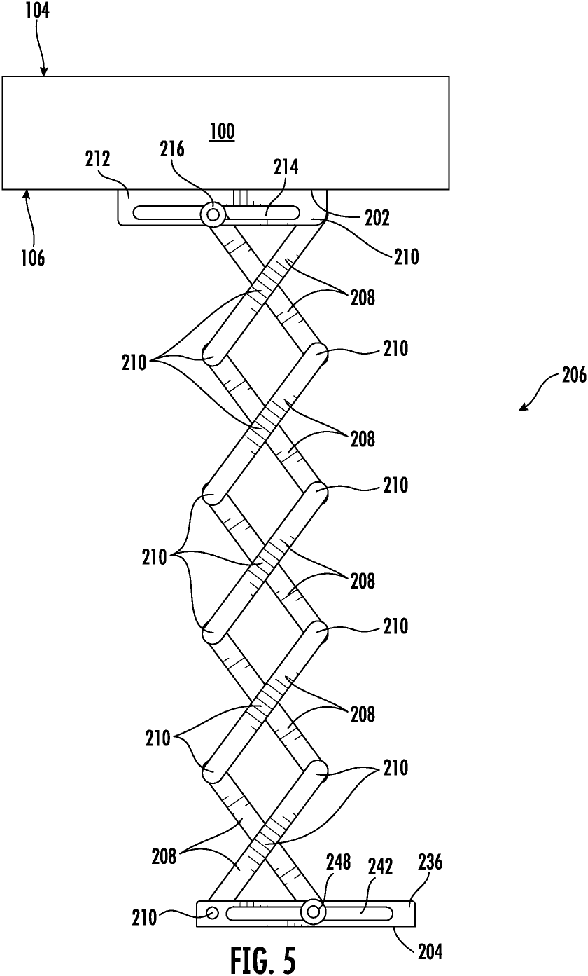

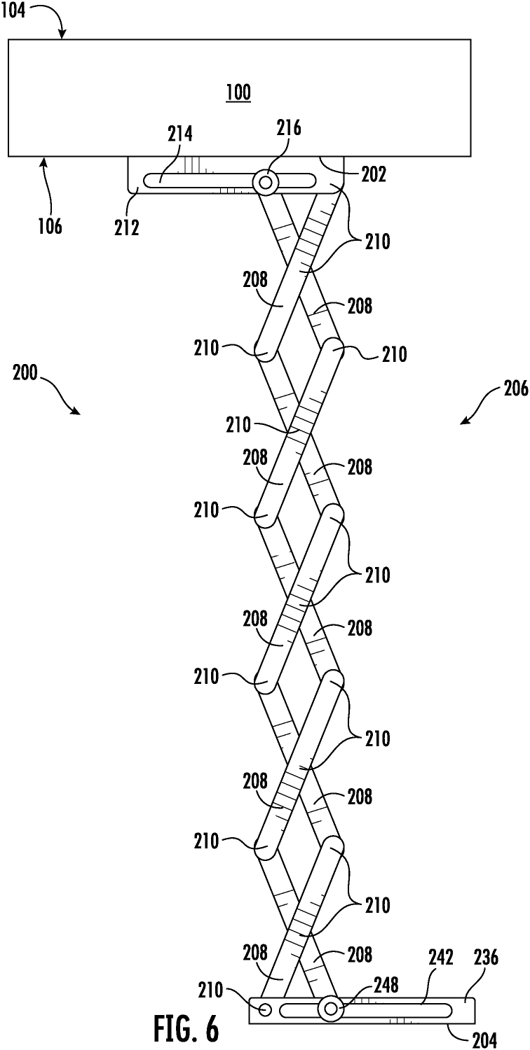

As illustrated in FIGS. 3 through 6, the folding robotic arm 200 may be mounted to a lower side 106 of a UAV 100. FIGS. 3 through 6 illustrate a transition or sequence of motion for the folding robotic arm 200 from a retracted, folded position (FIG. 3), through a series of intermediate positions (FIGS. 4 and 5) to an extended, unfolded, position (FIG. 6). Where FIGS. 3 through 6 provide side views of the folding robotic arm 200, only one of the scissor arms 206 is visible. It is to be understood that the other scissor arm 206 is substantially identical to the illustrated scissor arm 206, e.g., the other scissor arm 206 may be a mirror of the illustrated scissor arm 206 in FIGS. 3 through 6.

Each scissor arm 206 includes a plurality of links 208 which are serially connected at a plurality of joints 210. Each joint 210 may be a movable joint 210, such as a revolute joint. Each scissor arm 206 may also include a top slider 212, e.g., at the proximal end of the folding robotic arm 200, such as the top slider 212 may be mounted to the lower side 106 of the UAV 100. A slot 214 may be formed in the top slider 212 and a roller 216 mounted to a first link 208 of the plurality of links 208 may be received within the slot 214.

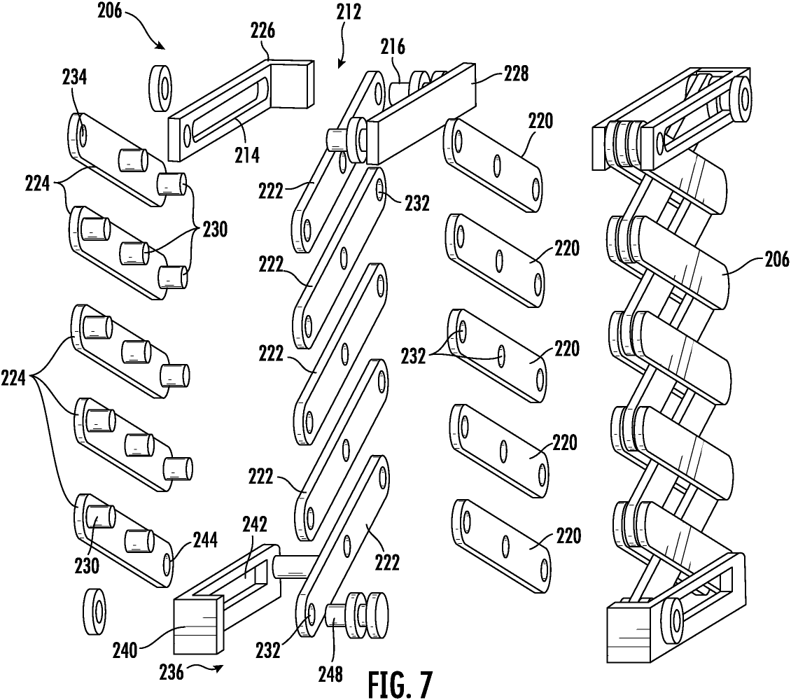

As may be seen, e.g., in FIG. 7, each scissor arm 206 may include various types of links, such as the plurality of links 208 may include a plurality of inner links 220, a plurality of center links 222, and a plurality of outer links 224. One set of links may include male fasteners, while one or more other sets of links may include holes which are configured to receive the male fasteners and thereby form the joints 210. For example, in the illustrated embodiments, e.g., as shown in FIG. 7, the plurality of outer links 224 includes male fasteners 230 on each outer link 224, while the plurality of inner links 220 and the plurality of center links 222 include holes 232 therethrough in which the male fasteners 230 may be received to form the scissor arm 206.

The top slider 212 may be coupled to one of the outer links 220, such as a top outer link 220. The top slider 212 may include an outer bracket 226, e.g., in which the slot 214 is formed. The top slider 212 may also include an inner bracket 228 which is coupled to the outer bracket 226 with the top outer link 220 therebetween. The top outer link 220 may include male fasteners, as described above, e.g., by which joints 210 with adjacent center links 222 and inner links 224 may be formed, and the top outer link 220 may further include an aperture 234 through which the roller 216 extends when the scissor arm 206 is assembled. The top slider 212 may be positioned at, and/or may define, the proximal end 202 of the folding robotic arm 200, such as the top sliders 212 of each scissor arm 206, e.g., both scissor arms 206, may collectively define the proximal end 202.

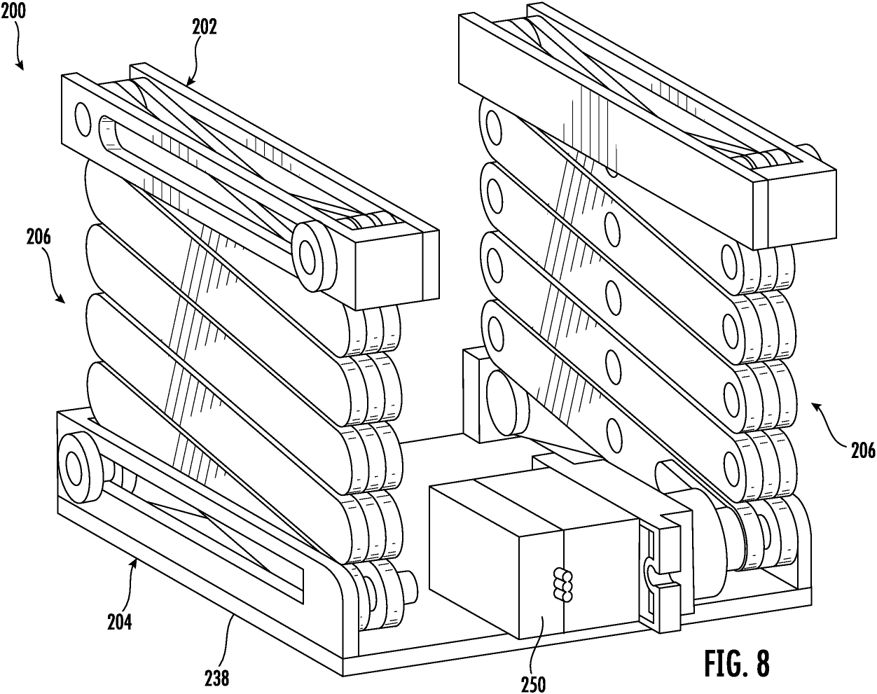

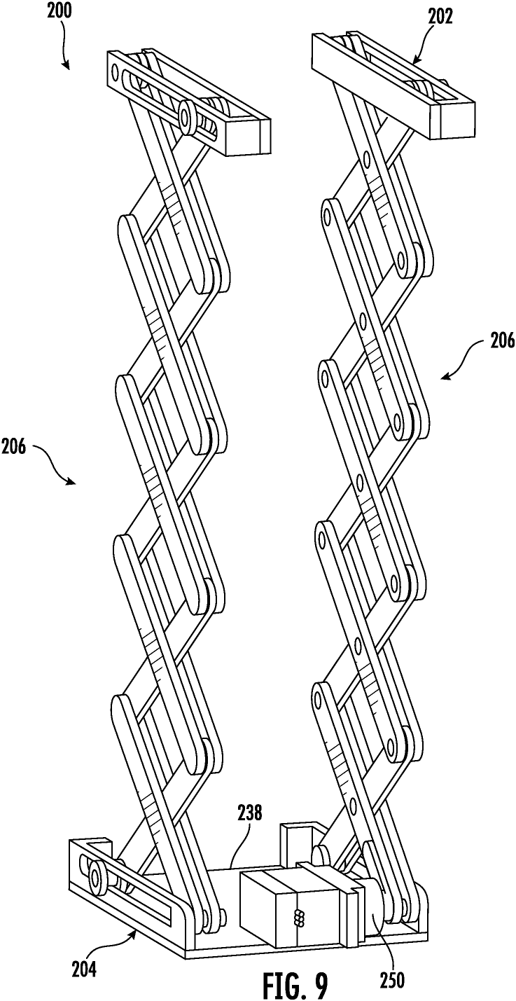

A bottom slider 236 may be provided opposite each top slider 212. Thus, the bottom sliders 236, e.g., both bottom sliders 236 of the pair of scissor arms 206, may be located at the distal end 204 of the folding robotic arm 200. In some embodiments, e.g., as illustrated in FIGS. 8 and 9, the folding robotic arm 200 may also include a base plate 238, e.g., at the distal end 204. As will be understood by those of ordinary skill in the art, an end effector may be attached to the folding robotic arm 200 at the base plate 238. For example, the bottom slider 236 may be coupled to one of the center links 222, such as a bottom center link 222 via the roller 248. The bottom slider 236 may include a bracket 240, e.g., with a slot 242 defined in and through the outer bracket 240 of the bottom slider 236. For example, a roller 248 of the bottom slider 236 may extend through one of the holes 232 in the bottom center link 222 when the scissor arm 206 is assembled. A bottom outer link 224 may include an aperture 244 and the bottom outer link 224 may be attached to the bottom slider 236, such as at a non-sliding pivot joint, e.g., a revolute joint with only a single degree of freedom of motion, via the aperture 244 in the bottom outer link 224.

As illustrated in FIGS. 8 and 9, the folding robotic arm 200 may include an actuator 250, and the actuator 250 may be configured to move the folding robotic arm 200 between the retracted position, e.g., FIG. 8, and the extended position, e.g., FIG. 9. The actuator 250 may move within a single degree of freedom to move the folding robotic arm 200 between the retracted position and the extended position. For example, the actuator 250 may be or include a motor, such as a DC motor, e.g., a brushless DC motor, a stepper motor, or a servo motor. Any suitable motor may be provided, such as a motor which has a high holding torque to overcome the weight of the folding robotic arm 200 and an external object, such as a sample acquired using the folding robotic arm 200. Preferably, the motor may have a high torque and low speed, or may provide precision control of the position of the folding robotic arm 200.

In some embodiments, the single degree of freedom of the actuator 250 may correspond to a rotation, e.g., the actuator 250 may rotate within and along a single direction of rotation to extend the folding robotic arm 200 and may rotate within and along a directly opposite direction of rotation to retract the folding robotic arm 200. For example, as illustrated in FIGS. 8 and 9, the actuator 250 may be coupled to one of the plurality of links 208 of one or both of the scissor arms 206 which comprise the folding robotic arm 200 in the exemplary embodiment illustrated in FIGS. 8 and 9. In such embodiments, the actuator 250 may be configured to rotate the one link 208 in order to extend or retract the folding robotic arm 200. In additional embodiments, the scissor arms 206 may be actuated by a linear actuator, e.g., an actuator wherein the single degree of freedom of the actuator corresponds to a linear translation. For example, the linear actuator may push or pull the bottom links or top links in a generally horizontal direction, whereupon the respective link or links slides within the corresponding slot of the top slider or bottom slider to extend or retract the folding robotic arm 200.

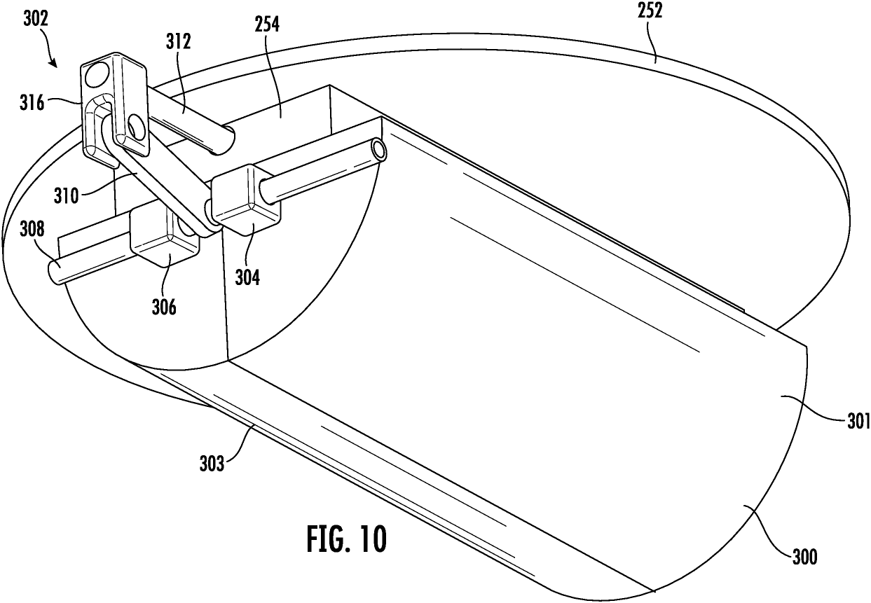

In some embodiments, the UAV 100 may also include a shell 300. For example, the shell 300 is illustrated in combination with an embodiment of the folding robotic arm 200 in FIGS. 10 through 18. However, it should be understood that the shell 300 is not limited to any particular arm configuration and may be provided in combination with any of the exemplary folding robotic arms 200 disclosed herein. The shell 300 may protect the folding robotic arm 200 during flight, and may improve the aerodynamics of the UAV 100 with the folding robotic arm 200 attached, such as by providing a smooth exterior surface with reduced wind resistance as compared to the folded arm 200. The shell 300 may be mounted to the lower side 106 of the body 102 of the UAV 100.

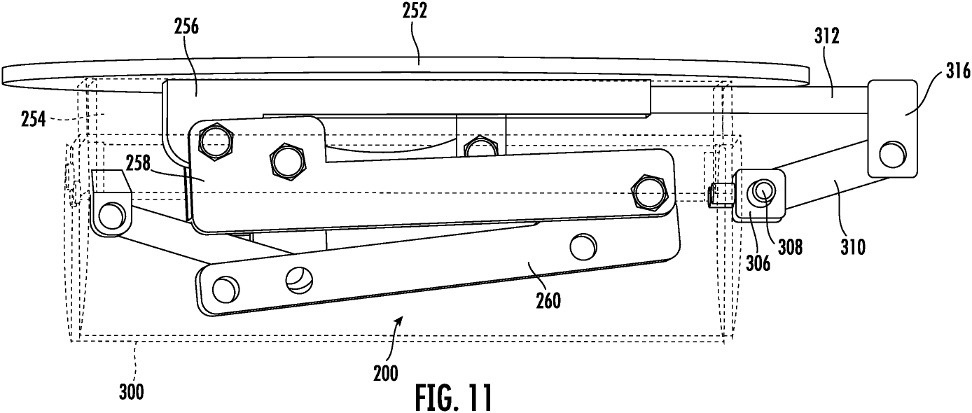

As may be seen, e.g., in FIGS. 10 and 11, in embodiments where the shell 300 is provided, the folding robotic arm 200 may be disposed within the shell 300, e.g., when the folding robotic arm 200 is in the retracted position, the folding robotic arm 200 may be fully within and entirely enclosed by the shell 300, such as fully enclosed on all sides by the shell 300 in cooperation with the body 102 of the UAV 100. In some embodiments, the folding robotic arm 200 may be generally enclosed within the shell 300 when the shell 300 is closed and the folding robotic arm 200 is retracted, such as at least ninety percent of the folding robotic arm 200 may be inside the shell 300. The shell 300 may be positioned below and around the folding robotic arm 200 when the folding robotic arm 200 is in the retracted position. For example, the shell 300 is illustrated in dashed lines in FIG. 11, such that the folding robotic arm 200 therein is thus visible in FIG. 11.

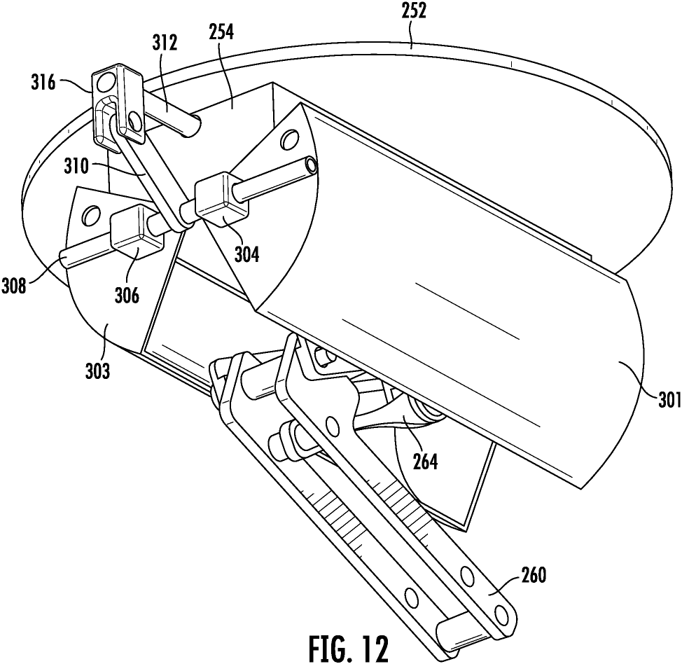

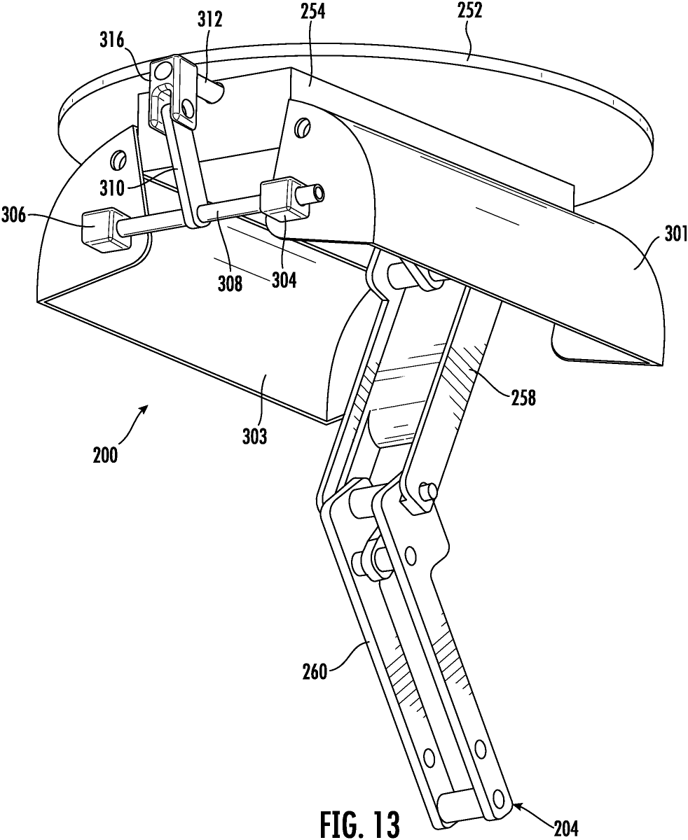

FIGS. 12 and 13 illustrate the exemplary folding robotic arm 200 and shell 300 moving at the same time as the folding robotic arm 200 transitions from the retracted position (FIGS. 10 and 11), through a series of intermediate positions such as the intermediate position depicted in FIG. 12, to the extended position (FIG. 13). The shell 300 may be coupled to an opening mechanism 302, and the opening mechanism 302 may also be coupled to the actuator 250, such that the shell 300 opens as the folding robotic arm 200 extends and closes as the folding robotic arm 200 retracts. For example, the shell 300 may include a first segment 301 and a second segment 303, and each segment 301, 303 may include a bracket 304, 306 thereon. The opening mechanism 302 may include a cross bar 308 which extends through each bracket 304 and 306. The cross bar 308 may be coupled to an opening link 310, and the opening link 310 may be coupled to a base slider 312. In such embodiments, the actuator 250 may be a linear actuator, and may move the base slider 312 in a generally horizontal direction to both extend or retract the folding robotic arm 200 and open or close the shell 300 at the same time. The opening mechanism 302 may further include an opening clip 316 coupled to an end of the base slider 312 and the opening link 310 may be coupled to and extend between the opening clip 316 and the cross bar 308.

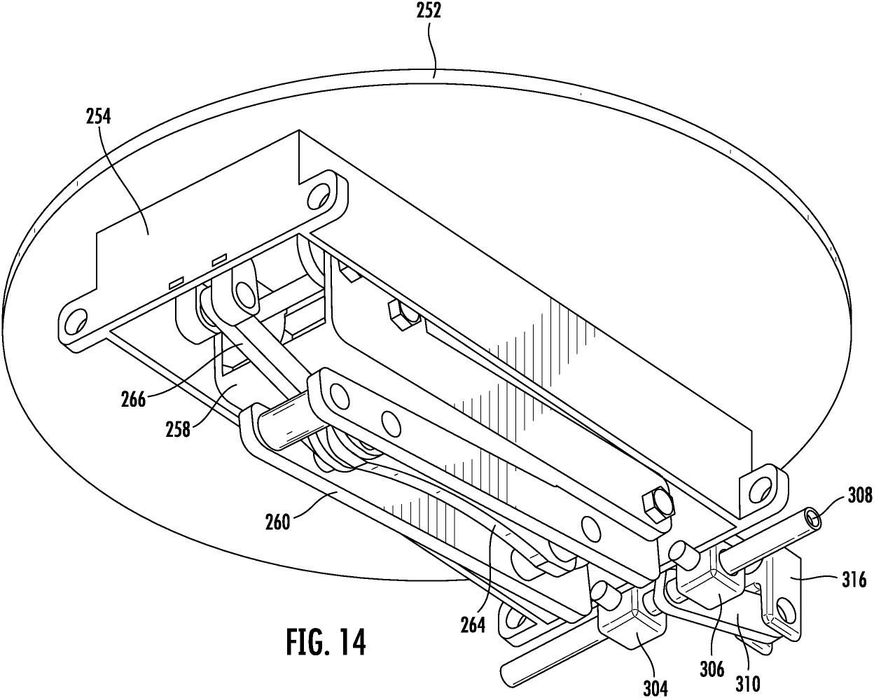

Referring now to FIGS. 14 through 18, in some embodiments, the folding robotic arm 200 may include a mounting plate 252, e.g., at the proximal end 202 of the folding robotic arm 200, which maybe mounted directly to and in contact with the lower side 106 (FIGS. 2-6) of the body 102 of the UAV 100. The exemplary embodiment of the folding robotic arm 200 illustrated in FIGS. 14 through 17 also includes a housing 254 on the mounting plate 252. The actuator 250 is not specifically illustrated in FIGS. 14 through 17, where those of ordinary skill in the art will recognize that the actuator 250 may be positioned within the housing 254. A base mount 256 may couple the folding robotic arm 200 to the mounting plate 252 within the housing 254. The base slider 312 which actuates the folding robotic arm 200, and may also actuate the shell 300 in embodiments where the shell 300 is provided as described above, may be positioned within the housing 254, above the base mount 256 and below the mounting plate 252.

Still referring to FIGS. 14 through 18, in some embodiments, the folding robotic arm 200 may comprise two links, e.g., an upper link 258 and a lower link 260 joined to the upper link 258, e.g., at a revolute joint located at approximately a mid point of the folding robotic arm 200. The upper link 258 may be joined to the base mount 256 at a first end of the upper link 258, such as by a rotational joint. The upper link 258 may be joined to a first end of the lower link 260 at a second, opposite, end of the upper link 258, also by a rotational joint. Any suitable end effector may be joined to a second, opposite, end of the lower link 260. Movement, e.g., folding and unfolding or extension and retraction, of the folding robotic arm 200 may be assisted by an outer slider 262. The upper link 258 may be connected to the base slider 312 by a base slider link 314. An outer slider link 264 may connect to and extend between the outer slider 262 at a first end and the lower link 260 at a second end opposite the first end of the outer slider link 264. A push link 266 may connect to and extend between the outer slider 262 at a first end and the upper link 258 at a second end opposite the first end of the push link 266. In such embodiments, the upper link 258 and the lower link 260 may be parallel or approximately parallel in the retracted, folded, position (see, e.g., FIGS. 11 and 14) and may form an angle of less than one hundred eighty degrees in the extended, unfolded, position (see, e.g., FIGS. 13, 15, and 16). For example, an extended position angle of more than one hundred thirty-five degrees and less than one hundred eighty degrees may advantageously promote simpler actuation of the folding robotic arm 200, e.g., by avoiding a singularity in the mechanism. Also by way of example, the upper link 258 and the lower link 260 being parallel or approximately parallel in the retracted, folded, position may advantageously minimize the volume of space occupied by the folding robotic arm 200 in the retracted position. In some embodiments, one or more biasing elements, e.g. springs, may be incorporated into the folding robotic arm 200 and/or shell 300 to promote movement such as opening or closing the shell 300 and/or folding and unfolding the arm 200.

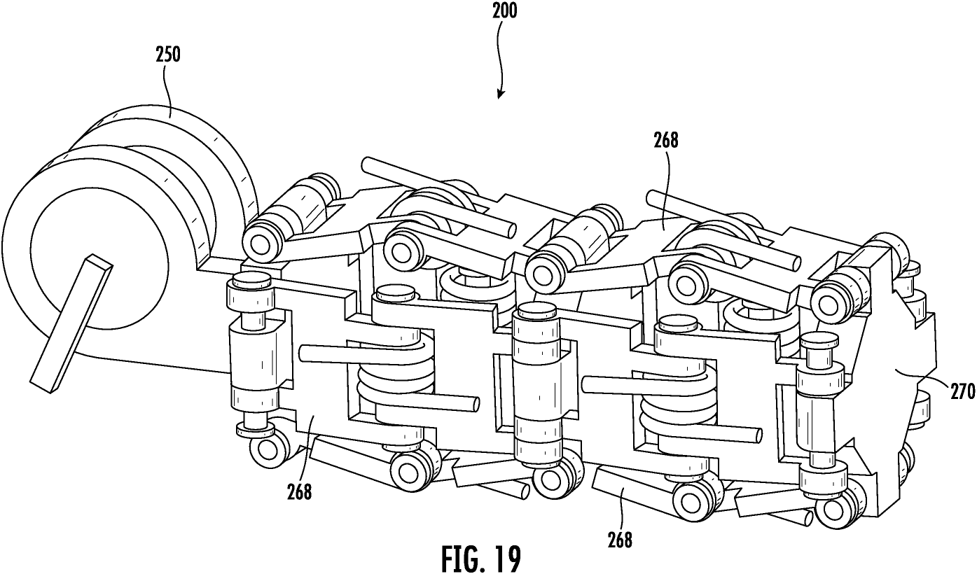

Referring now to FIGS. 19 through 21, in some embodiments, the folding robotic arm 200 may include one or more Sarrus linkages 268, such as four Sarrus linkages 268 each coupled to a respective side of an end plate 270 of the folding robotic arm 200 at the distal end 204 of the folding robotic arm 200. Further, any suitable end effector as desired for a particular application of the folding robotic arm 200 may be mounted at the end plate 270. Each Sarrus linkage 268 may include one or more pairs of links 272, e.g., plates as in the illustrated exemplary embodiments of FIGS. 19 through 21, which are hingedly joined by a respective hinge pin 274 and hinge pin nut 276. In such embodiments, the folding robotic arm 200 may be biased to or towards the extended position, such as by one or more biasing elements 278, e.g., coil springs. A biasing element 278 may be provided at some or all of the hinge joints between the links 272 of the Sarrus linkages 268.

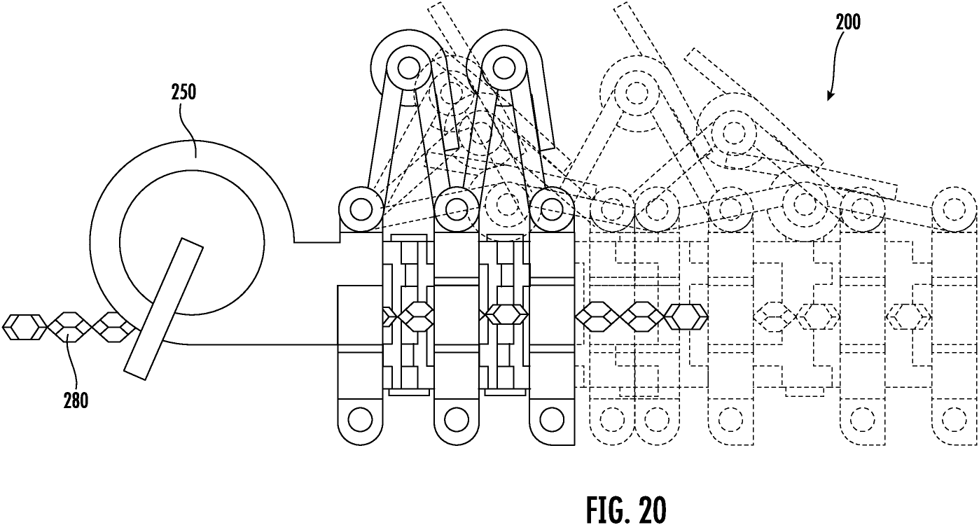

Still with reference to FIGS. 19 through 21, in such embodiments, the folding robotic arm 200 may be linearly actuated. For example, the actuator 250 may be or include a pulley and motor. A tether 280 may be coupled to the actuator 250 at a first end of the tether 280 and may be coupled to the end plate 270 at a second end of the tether 280 opposite the first end of the tether 280. Accordingly, to retract or fold the folding robotic arm 200 in such embodiments, the actuator 250 may pull the tether 280 along a straight line, e.g., generally perpendicular to the end plate 270 such as upwards towards the body 102 of the UAV 100, to overcome the force of the biasing element(s) 278. Thus, the folding robotic arm 200 may collapse to the folded, retracted position. As may be seen for example in FIG. 20, the folded, retracted position of the folding robotic arm 200 is illustrated in solid lines, whereas the extended position and several intermediate positions are illustrated in dashed lines.

One or more brace plates 282 may be provided between the end plate 270 and the actuator 250. The one or more brace plates 282 may promote or enhance the lateral stability of the folding robotic arm 200, such as by cross linking two or more Sarrus linkages 268 together. The brace plates 282 may comprise a plurality of sides, such as a plurality of sides which corresponds in number to the Sarrus linkages 268, e.g., the brace plate(s) 282 may include four sides and each of the four sides may be coupled to a corresponding one of the four Sarrus linkages as in the illustrated exemplary embodiment. The brace plate 282 (or each brace plate 282 in embodiments where more than one brace plate 282 is provided) may also include a central aperture 284, such as the tether 280 may extend through each brace plate 282 via the central aperture 284 thereof.

In some exemplary embodiments, the folding robotic arm 200 may be positioned and oriented at an oblique angle to the body 102 of the UAV 100, such as the folding robotic arm 200 may fold and unfold along a single linear direction or axis, and the single linear direction or axis may be oriented along an angle that is oblique to the vertical direction and/or oblique to the body 102 of the UAV 100. For example, as illustrated in FIGS. 22 and 23, the proximal end 202 of the folding robotic arm 200 may include an angled mounting bracket 288. In such embodiments, the angled mounting bracket 288 may include a first plate 290, e.g., an upper plate, which may be configured to attach directly to the lower side 106 of the body 102 of the UAV 100. Thus, the first plate 290 may be approximately parallel to the lower side 106 of the body 102 of the UAV 100, such as may be approximately parallel to a horizontal direction and/or approximately perpendicular to the vertical direction. The angled mounting bracket 288 may also include a second plate 292, and the second plate 292 may be joined to the first plate 290 at an edge of the plates 290, 292. The second plate 292 may be oriented at an angle to the first plate 290, such as at an oblique angle. The remainder of the folding robotic arm 200 may extend from the second plate 292 of the angled mounting bracket 288, thereby orienting the folding robotic arm 200 substantially at an oblique angle to the UAV 100, e.g., whereby the folding robotic arm 200 extends and retracts (folds and unfolds) along a single linear direction or axis that is oblique to the vertical direction and/or oblique to the main body 102 of the UAV 100.

The present disclosure provides numerous advantages as will be appreciated by those of ordinary skill in the art. For example, the folding robotic arm 200 may be actuated by a single actuator 250, thereby reducing the complexity, weight, and power consumption of the folding robotic arm 200, e.g., as compared to more complex articulators or arms which include multiple actuators. Additionally, the actuator may also move in a singe degree of freedom of motion and such limited motion of the actuator may also promote improved weight and power consumption. It is to be understood that the foregoing advantages are provided by way of example only and without limitation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An unmanned aerial vehicle, comprising:
a body comprising an upper side and a lower side opposite the upper side;
at least one rotor coupled to the body, the rotor configured to generate lift in an upward direction;
an arm mounted to the lower side of the body;
an actuator coupled to the arm, the actuator configured to move the arm between a retracted position and an extended position, wherein the actuator moves within a single degree of freedom to move the arm between the retracted position and the extended position.

2. The unmanned aerial vehicle of claim 1, wherein the single degree of freedom of the actuator corresponds to a linear translation.

3. The unmanned aerial vehicle of claim 1, wherein the single degree of freedom of the actuator corresponds to a rotation.

4. The unmanned aerial vehicle of claim 1, further comprising a shell mounted to the lower side of the body, wherein the arm is disposed within the shell and the shell is positioned below and around the arm when the arm is in the retracted position.

5. The unmanned aerial vehicle of claim 1, wherein the arm is a foldable arm comprising a plurality of links.

6. The unmanned aerial vehicle of claim 5, wherein the arm is a first scissor arm, wherein the plurality of links comprises a first set of links serially connected with each other to form the first scissor arm, further comprising a second scissor arm parallel to the first scissor arm.

7. The unmanned aerial vehicle of claim 5, wherein the plurality of links comprises an upper link coupled to the lower side of the body at a proximal end of the upper link and a lower link coupled to a distal end of the upper link.

8. The unmanned aerial vehicle of claim 1, wherein the arm comprises a Sarrus linkage.

9. The unmanned aerial vehicle of claim 8, further comprising a biasing element coupled to the Sarrus linkage, the biasing element positioned and configured to bias the arm to the extended position.

10. The unmanned aerial vehicle of claim 1, further comprising an end effector coupled to a distal end of the arm.

11. An unmanned aerial vehicle, comprising:
a body;
an arm mounted to a side of the body;
an actuator coupled to the arm, the actuator configured to move the arm between a retracted position and an extended position, wherein the actuator moves within a single degree of freedom to move the arm between the retracted position and the extended position.

12. The unmanned aerial vehicle of claim 11, wherein the single degree of freedom of the actuator corresponds to a linear translation.

13. The unmanned aerial vehicle of claim 11, wherein the single degree of freedom of the actuator corresponds to a rotation.

14. The unmanned aerial vehicle of claim 11, further comprising a shell mounted to the side of the body, wherein the arm is disposed within the shell when the arm is in the retracted position.

15. The unmanned aerial vehicle of claim 11, wherein the arm is a foldable arm comprising a plurality of links.

16. The unmanned aerial vehicle of claim 15, wherein the arm is a first scissor arm, wherein the plurality of links comprises a first set of links serially connected with each other to form the first scissor arm, further comprising a second scissor arm parallel to the first scissor arm.

17. The unmanned aerial vehicle of claim 15, wherein the plurality of links comprises an upper link coupled to the lower side of the body at a proximal end of the upper link and a lower link coupled to a distal end of the upper link.

18. The unmanned aerial vehicle of claim 11, wherein the arm comprises a Sarrus linkage.

19. The unmanned aerial vehicle of claim 18, further comprising a biasing element coupled to the Sarrus linkage, the biasing element positioned and configured to bias the arm to the extended position.

20. The unmanned aerial vehicle of claim 11, further comprising an end effector coupled to a distal end of the arm.
